(19) United States
(12) Patent Application Publication
(10) Pub. No.: US 2025/0269568 A1
(43) Pub. Date: Aug. 28, 2025

(54) MOLD APPARATUS

(71) Applicant: SAMSUNG ELECTRONICS CO., LTD., Suwon-si (KR)

(72) Inventors: Myeonghun KIM, Suwon-si (KR); Mincheol KIM, Suwon-si (KR); Sejong PARK, Suwon-si (KR); Sangmin LEE, Suwon-si (KR); Kyomin CHOO, Suwon-si (KR); Dohyeon PARK, Suwon-si (KR)

(73) Assignee: SAMSUNG ELECTRONICS CO., LTD., Suwon-si (KR)

(21) Appl. No.: 19/207,538

(22) Filed: May 14, 2025

Related U.S. Application Data
(63) Continuation of application No. PCT/KR2023/014365, filed on Sep. 21, 2023.

(30) Foreign Application Priority Data
Dec. 2, 2022 (KR) 10-2022-0166790

(51) Int. Cl. B29C 43/36; B29C 43/40; B29L 31/00

(52) U.S. Cl. CPC B29C 43/361; B29C 2043/403; B29L 2031/724

(57) ABSTRACT

A mold apparatus for manufacturing a door having an opening by shearing a door intermediate product. The mold apparatus including a lower mold to correspond to a door intermediate product; and an upper mold, to correspond to the door intermediate product, to be positioned above the lower mold. The upper mold including a blade extending along a side surface of the door intermediate product to cut out the side surface of the door intermediate product; and a guide plate, including an insertion hole, to guide a movement of the blade along the horizontal direction; and a presser, including a push protrusion, that is moved through the insertion hole in one direction perpendicular to the horizontal direction, where the push protrusion protrudes from the side surface of the presser to push the guide plate along the horizontal direction when the presser is moved along the one direction.

### CROSS-REFERENCE TO RELATED APPLICATION

This application is a continuation application is a continuation application, under 35 U.S.C. § 111(a), of international application No. PCT/KR2023/014365, filed Sep. 21, 2023, which claims priority under 35 U.S.C. § 119 to Korean Patent Application No. 10-2022-0166790, filed Dec. 2, 2022, the disclosures of which are incorporated herein by reference in their entireties.

### TECHNICAL FIELD

The disclosure relates to a mold apparatus, and to a mold apparatus for manufacturing a door.

### BACKGROUND ART

In general, a refrigerator includes a main body having an open front and a storage compartment formed therein, and a door installed on the front of the main body to open and close the open front.

The main body includes an outer case forming an exterior, an inner case installed inside the outer case for an interior space thereof to form a storage compartment, and a foam insulation material filled between the inner case and the outer case to insulate the storage compartment.

In general, a method of forming a door may employ a thermoforming method in which a thermoplastic plastic is heated to a forming temperature and then shaped into a container form, and a product formed by the thermoforming method may be subject to a trimming process through a shearing mold to form a door.

The mold apparatus may include an upper mold and a lower mold that are coupled to each other and have shapes corresponding to a shape of a product to be manufactured between the upper mold and the lower mold.

### DISCLOSURE

### Technical Problem

One aspect of the disclosure provides a mold apparatus capable of performing an improved processing process in processing a door.

One aspect of the disclosure provides a mold apparatus capable of performing shearing such that the front of an inner door is opened.

Technical objects of the disclosure are not limited to those described above, and other technical objects not described herein will also be clearly understood by a person who has a common knowledge in the technical field to which the disclosure pertains from the following detailed description.

### Technical Solution

A mold apparatus for manufacturing a door having an opening by shearing a door intermediate product according to an embodiment includes: a lower mold to correspond to the door intermediate product; and an upper mold to correspond to the door intermediate product and positioned above the lower mold. The upper mold includes: a blade extending along a side surface of the door intermediate product to cut a side surface of the door intermediate product; a guide plate, including an insertion hole, configured to guide a movement of the blade along a horizontal direction; and a presser, including a push protrusion, configured to move along one direction perpendicular to the horizontal direction through the insertion hole, wherein the push protrusion protrudes from a side surface of the presser to push the guide plate along the horizontal direction as the presser moves along the one direction.

The side surface of the presser may be a first side surface facing a first direction in a horizontal direction and the presser includes a second side surface facing a second direction along a horizontal direction different from the first direction, and the push protrusion may be a first push protrusion formed on the first side surface and the presser includes a second push protrusion on the second side surface and provided at a height different from a height of the first push protrusion.

The upper mold may further include an interference member between the presser and the guide plate to interfere with the push protrusion.

The upper mold may further include a coupling member, coupleable to the guide plate, configured to move the guide plate via the interference member, and the interference member may be configured to rotate around the coupling member.

The interference member may be configured to rotate around the coupling member as the presser moves in another direction opposite to the one direction.

The presser may further include a recessed portion adjacent to the push protrusion and into which the interference member may be insertable.

The push protrusion may include a first inclined surface protruding from the side surface to be inclined toward the guide plate, a connecting surface extending from one end thereof connected to the first inclined surface, and a second inclined surface extending from the other end of the connecting surface and inclined toward the side surface.

The recessed portion may include a bottom surface including one end connected to the first inclined surface, and a guide surface extending parallel to the second inclined surface from the other end of the bottom surface.

The interference member may include a first slide surface inclined parallel with the first inclined surface to be slidable relative to the first inclined surface, and a second slide surface inclined parallel with the second inclined surface to be slidable relative to the second inclined surface.

The side surface of the presser may include a first side surface facing a first direction along a horizontal direction, and the presser includes a second side surface facing a second direction that is opposite to the first direction along the horizontal direction. The push protrusion may include a first push protrusion formed on the first side surface, and a second push protrusion formed on the second side surface and positioned upward of the first push protrusion. The upper mold may include a first interference member between the presser and the guide plate to interfere with the first push protrusion, and a second interference member provided between the presser and the guide plate to interfere with the second push protrusion.

The presser may include a first recessed portion formed on the first side surface at a height of the second push protrusion, and a second recessed portion on the second side surface at a height of the first push protrusion.

The first push protrusion may include a first inclined surface inclined upward from the first side surface and a second inclined surface inclined downward from a bottom surface of the first recessed portion. The second push protrusion may include a third inclined surface inclined downward from the second side surface and a fourth inclined surface inclined upward from a bottom surface of the second recessed portion. The first interference member may include a first slide surface extending parallel to the first inclined surface to be slidable on the first inclined surface, and a second slide surface extending parallel to the second inclined surface to be slidable on the second inclined surface and positioned downward of the first slide surface. The second interference member may include a third slide surface extending parallel to the fourth inclined surface to be slidable on the fourth inclined surface, and a fourth slide surface extending parallel to the third inclined surface to be slidable on the third inclined surface.

The blade may be insertable into the door intermediate product to cut the side surface of the door intermediate product.

The interference member may include a hinge coupling portion into which a hinge shaft configured to rotate the interference member is insertable, the hinge coupling portion being coupled to the coupling member. The coupling member may include a hinge fixing portion into which the hinge shaft is insertable.

The upper mold may further include a connecting plate coupled to the blade and configured to move the blade along the horizontal direction in response to the guide plate being moved along the horizontal direction.

### Advantageous Effects

According to the concept of the disclosure, since an outer trim process, a front trim process, and a side cam piercing process are performable using a single mold apparatus, the quality and manufacturing speed of a door can be improved.

According to the concept of the disclosure, since a trimming process in which a front of a door intermediate product is opened is performable by a movement of a presser in one direction, a door can be manufactured relatively easily.

According to the concept of the disclosure, since a side surface of an inner door is prevented from being double-sheared in a shear mold, the quality of the inner door can be relatively improved.

### DESCRIPTION OF DRAWINGS

FIG. 1 is a perspective view of a refrigerator according to an embodiment of the disclosure with an outer door open.

FIG. 2 is an exploded view of an inner door of a refrigerator according to an embodiment of the disclosure.

FIG. 3 is a perspective view of an inner door according to an embodiment of the disclosure.

FIG. 4 is an exploded view of a mold apparatus according to an embodiment of the disclosure.

FIG. 5 is a perspective view of an upper mold of a mold apparatus according to an embodiment of the disclosure.

FIG. 6 is a side-sectional view of a shearing portion shown in FIG. 5 according to an embodiment of the disclosure.

FIG. 7 is a perspective view of a presser shown in FIG. 5 according to an embodiment of the disclosure.

FIG. 8 is a plan view of a presser shown in FIG. 7 according to an embodiment of the disclosure.

FIG. 9 is a plan view of a presser shown in FIG. 7, when viewed from a different angle according to an embodiment of the disclosure.

FIG. 10 is a perspective view of an interference member shown in FIG. 5 according to an embodiment of the disclosure.

FIG. 11 is a perspective view of a coupling member shown in FIG. 5 according to an embodiment of the disclosure.

FIG. 12 is a schematic view of a shearing process of an inner door frame according to an embodiment of the disclosure.

FIG. 13 is an enlarged side-sectional view for describing an outer trimming process of an upper mold according to an embodiment of the disclosure.

FIG. 14 is an enlarged view of part A of FIG. 13, showing a state before the upper mold is moved toward the lower mold according to an embodiment of the disclosure.

FIG. 15 is an enlarged view of part A of FIG. 13, showing a state after the upper mold is moved toward the lower mold according to an embodiment of the disclosure.

FIG. 16 is a perspective view showing a state in which a first push protrusion of a presser is moved downward toward a guide plate and interferes with a first interference member according to an embodiment of the disclosure.

FIG. 17 is a sectional view of an upper mold and an inner door frame taken along line I-I′ of FIG. 16 according to an embodiment of the disclosure.

FIG. 18 is a perspective view showing a state in which a second push protrusion of a presser is moved downward toward a guide plate and interferes with a second interference member according to an embodiment of the disclosure.

FIG. 19 is a sectional view of an upper mold and an inner door frame taken along line II-II′ of FIG. 18 according to an embodiment of the disclosure.

FIG. 20 is a perspective view showing a state in which a third push protrusion of a presser is moved downward toward a guide plate and interferes with a third interference member according to an embodiment of the disclosure.

FIG. 21 is a sectional view illustrating an upper mold and an inner door frame taken along line III-III′ of FIG. 20 according to an embodiment of the disclosure.

FIG. 22 is a perspective view showing a state in which a fourth push protrusion of a presser is moved downward toward a guide plate and interferes with a fourth interference member according to an embodiment of the disclosure.

FIG. 23 is a sectional view of an upper mold and an inner door frame taken along line IV-IV′ of FIG. 22 according to an embodiment of the disclosure.

FIG. 24 is a side sectional view showing a process in which a push protrusion of a presser is moved toward an upper side e of a guide plate to rotate an interference member according to an embodiment of the disclosure.

FIG. 25 is an enlarged side surface-sectional view showing a side cam piercing process of an upper mold according to an embodiment of the disclosure, which shows a state before a side cam moves toward an inner door frame.

FIG. 26 is an enlarged side surface-sectional view showing a side cam piercing process of an upper mold according to an embodiment of the disclosure, which shows a state after a side cam moves toward an inner door frame.

### MODES OF THE INVENTION

The embodiments described in the disclosure and the configurations shown in the drawings are only examples of the disclosure, and various modifications may be made at the time of filing of the disclosure to replace the embodiments and drawings of the disclosure.

In the description of the drawings, like numbers refer to like elements throughout the description of the drawings.

The terms used herein are for the purpose of describing the embodiments and are not intended to restrict and/or to limit the disclosure. The singular expressions herein may include plural expressions, unless the context clearly dictates otherwise. In addition, the terms “comprises”, “includes”, and “has” are intended to indicate that there are features, numbers, steps, operations, elements, parts, or combinations thereof described in the disclosure, and do not exclude the presence or addition of one or more other features, numbers, steps, operations, elements, parts, or combinations thereof.

It will be understood that, although the terms first, second, etc. used in the disclosure may be used herein to describe various components, these components should not be limited by these terms. These terms are only used to distinguish one component from another. For example, a first element could be termed a second element, and similarly, a second element could be termed a first element without departing from the scope of the disclosure. The term “and/or” includes combinations of one or all of a plurality of associated listed items.

In the following description, the terms “front,” “rear,” “left,” and “right,” are defined based on the directions illustrated in the drawings, but the terms need not restrict the shape and position of the respective components.

Hereinafter, embodiments according to the present invention will be described in detail with reference to the attached drawings.

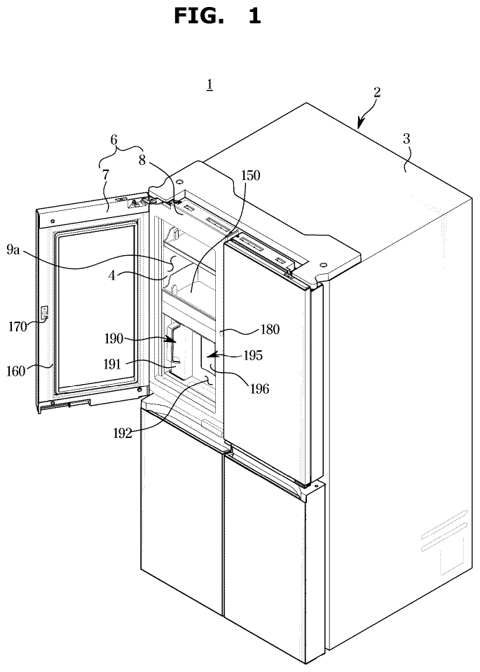

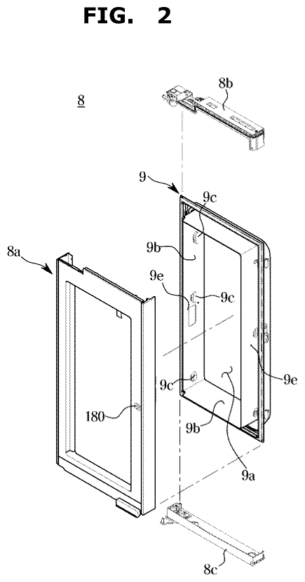

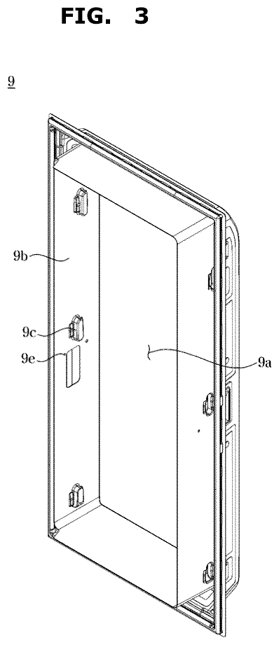

FIG. 1 is a perspective view showing an open outer door of a refrigerator according to an embodiment of the disclosure. FIG. 2 is a view showing an exploded inner door of a refrigerator according to an embodiment of the disclosure. FIG. 3 is a perspective view showing an inner door according to an embodiment of the disclosure.

Referring to FIGS. 1 to 3, a refrigerator 1 may include a main body 2, a storage compartment formed inside the main body 2, a door 6 for opening and closing the storage compartment, and a cold air supply device (not shown) for supplying cold air to the storage compartment.

The main body 2 may include an inner case 4 forming a storage compartment, an outer case 3 coupled to the outside of the inner case 4 to form an exterior, and an insulating material (not shown) provided between the inner case 4 and the outer case 3 to insulate the storage compartment.

The cold air supply device may generate cold air using a cooling cycle of compressing, condensing, expanding, and evaporating a refrigerant, and supply the generated cold air to the storage compartment.

The refrigerator 1 may include a door 6 provided to open and close the storage compartment. The door 6 may be rotatably coupled to the main body 2.

The door 6 may include a door guard 150 having a door storage space for storing food. The door 6 may be provided on a rear surface thereof with a gasket that is attached to a front surface of the main body 2 to seal the storage compartment. The doors 6 may include four doors as shown in the drawing, but the disclosure is not limited thereto.

At least one of the doors 6 may be provided as a double door having an inner door 8 and an outer door 7. For example, an upper left door 6 may include an inner door 8 and an outer door 7.

The inner door 8 may be rotatably coupled to the main body 2 via a hinge. The inner door 8 may have an opening 9a. The opening 9a may be formed in a central portion excluding an edge portion of the inner door 8. The opening 9a may be formed to extend between a front surface and a rear surface rear of the inner door 8. Therefore, while the inner door 8 is closed, the opening 9a may be in communication with the storage compartment.

The opening 9a may be provided to mount the door guard 150 thereto.

The opening 9a may be provided with a dispenser 195 that includes a water dispensing space 192 and a manipulating lever 196. The dispenser 195 may supply water to the water dispensing space 192 by a manual operation of the manipulating lever 196.

The opening 9a may be provided with an autofill device 190 including a water level sensor that detects the water level of a water tank 191. The autofill device 190 may automatically supply water to the water tank 191 such that a predetermined amount of water is filled in the water tank 191 when the water tank 191 is installed in a water tank installation space (not shown).

The outer door 7 may be provided to open and close the opening 9a of the inner door 8. A gasket may be provided on the rear surface of the outer door 7 to seal the opening 9a. The gasket may be in close contact with the front surface of the inner door 8 around the opening 9a.

When the outer door 7 is opened, the opening 9a of the inner door 8 may be accessed. The outer door 7 may be rotatably coupled to the inner door 8 via a hinge. The outer door 7 may rotate in the same direction as the inner door 8. The outer door 7 may have a size corresponding to the size of the inner door 8. The outer door 7 may cover the entire area of the inner door 8.

The outer door 7 may be provided with a latch 170 for fixing with the inner door 8, and the inner door 8 may be provided with a catch 180 to engage with the latch 170.

While the latch 170 is engaged with the catch 180, opening the outer door 7 may allow the outer door 7 and the inner door 8 to open together, and while the latch 170 is not engaged with the catch 180, opening the outer door 7 may allow only the outer door 7 to open without the inner door 8 being opened.

The outer door 7 may have a decorative panel (not shown) detachably coupled to a front surface thereof.

The inner door 8 may include a front panel 8a, a rear panel 9, an upper cap 8b, and a lower cap 8c.

The front panel 8a may form a front surface and both side surfaces of the inner door 8. The front panel 8a may include a front opening excluding an edge portion of the front panel 8a.

The front panel 8a may be provided with a catch 180 to be engaged with the latch 170 of the outer door 7.

The rear panel 9 may be defined as an inner door frame 9. The inner door frame 9 may include an opening 9a formed in a central portion excluding an edge portion of the inner door frame 9. The inner door frame 9 may include side surfaces 9b forming the opening 9a. The side surfaces 9b of the inner door frame 9 may be formed on the upper, lower, and right sides of the opening 9a to form the opening 9a.

The inner door frame 9 may be provided with a door bead 9c formed on the side surface 9b to protrude from the side surface 9b toward the opening 9a, the door bead 9c being configured to mount the door guard 150 thereon. The door guard 150 may be mounted on the side surface 9b of the inner door frame 9 via the door bead 9c.

A passage 9e through which wires and hoses pass may be formed on the side surface 9b of the inner door frame 9.

The inner door frame 9 may be provided as a roughly quadrangular frame surrounding the opening 9a. The inner door frame 9 may include side surfaces 9b facing each other.

Since the inner door frame 9 needs to have an open front unlike the outer door frame (not shown), a mold apparatus for forming the inner door frame 9 may be different from a mold apparatus for forming the outer door frame.

Hereinafter, a mold apparatus 10 for forming the inner door frame 9 will be described in detail.

The inner door frame 9 may be manufactured through a shear mold after thermoforming. Thermoforming is a process of heating a thermoplastic plastic to a molding temperature and then forming the thermoplastic plastic into a container shape.

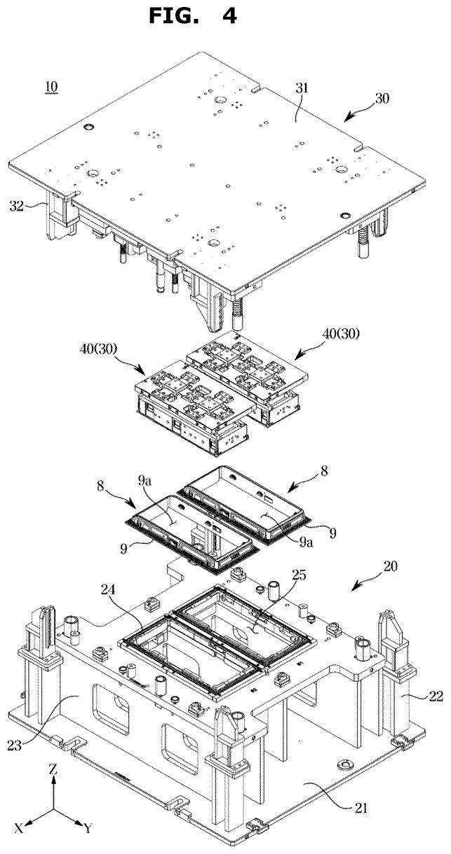

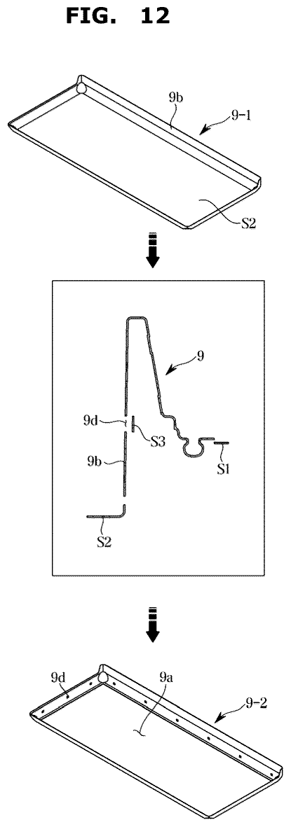

A molded part manufactured by the thermoforming is put into a mold apparatus (10, see FIG. 4) such that a first scrap S1 may be sheared through an outer trimming process of shearing the outer portion of the inner door frame 9, and a second scrap S2 may be sheared through an open trimming process of shearing the side surfaces 9b of the inner door frame 9 to form the opening 9a of the inner door frame 9. Finally, a third scrap S3 may be sheared through a side cam piercing process of forming a side hole in the side surface 9b of the inner door frame 9 for a door shelf (DS) (see FIG. 12). The mold apparatus 10 for this process will be described in detail below. In addition, the inner door frame 9 may be referred to as an inner door or a door for the sake of convenience of description below.

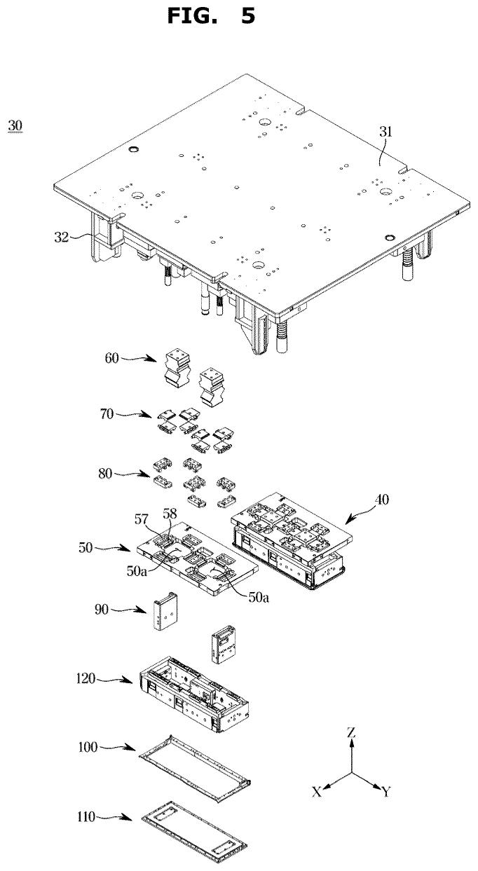

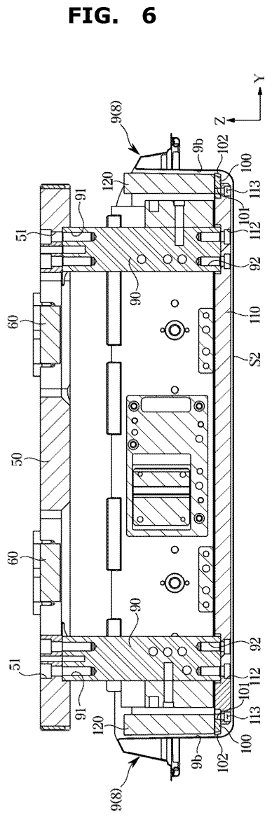

FIG. 4 is an exploded view of a mold apparatus according to an embodiment of the disclosure. FIG. 5 is a perspective view of an upper mold of a mold apparatus according to an embodiment of the disclosure. FIG. 6 is a side-sectional view of a shearing portion shown in FIG. 5.

Referring to FIGS. 4 to 6, the mold apparatus 10 may include a lower mold 20 positioned below the inner door frame 9 and provided to correspond to the inner door 8, and an upper mold 30 positioned above inner door frame 9 and provided to correspond to the inner door 8.

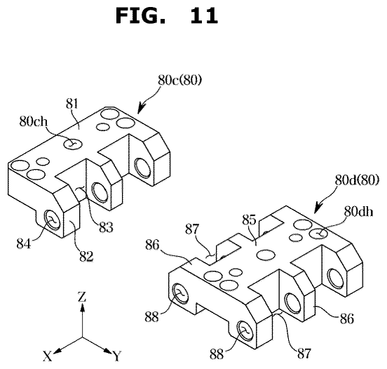

The lower mold 20 may include a lower mold base 21 supported on the floor, and a lower mold frame 23 including a seating portion 24 on which the inner door 8 is seated. A lower mold stand 22 may be provided to support the lower mold frame 23, and may be provided around the lower mold frame 23 while extending in the vertical direction (Z direction) to be coupled to the upper mold 30. The seating portion 24 may include a seating hole 25 for providing the second scrap (S2, see FIG. 11) of the inner door frame 9.

The upper mold 30 may include an upper mold base 31 provided on the upper side (Z direction) and facing the lower mold base 21. The upper mold 30 may include an upper mold stand 32 that protrudes from the upper mold base 31 toward the lower mold 20 and is coupled to the lower mold stand 22. The upper mold stand 32 may be provided at a position corresponding to the lower mold stand 22.

The upper mold 30 may include a shearing portion 40 provided on the lower side (−Z direction) of the upper mold base 31 while protruding from the upper mold base 31 toward the lower mold 20.

The shearing portion 40 may be a device for shearing the second scrap S2 and the third scrap S3 from the inner door frame 9 that is seated on the seating portion 24 of the lower mold 20 (see FIG. 11).

The inner door frame 9 shown in FIG. 4 illustrates a frame upon completion of the molding process, in which the second scrap S2 has been separated from the side surface 9b by the mold apparatus 10.

The shearing portion 40 may include a guide plate 50 extending in a horizontal direction and provided in a shape of an approximately rectangular parallelepiped. The shearing portion 40 may include a presser 60 that is provided to move in the up-down direction (Z direction) through an insertion hole 50a of the guide plate 50. The shearing portion 40 may include an interference member 70 that is interfered by the presser 60 and configured to move the guide plate 50 in a horizontal direction, and a coupling member 80 that is coupled to the interference member 70 to allow the interference member 70 to rotate and coupled to the guide plate 50.

Four interference members 70 may be arranged to correspond to a single insertion hole 50a and positioned in four directions in the horizontal direction of the insertion hole 50a. In addition, the coupling members 80 may be provided in plural for the single insertion hole 50a so as to be coupled to a single interference member 70.

The guide plate 50 may be formed to be larger than the inner door frame 9 and may have an insertion hole 50a into which the presser 60 is inserted. The guide plate 50 may include an interference member support portion 58 provided such that four interference members 70 are seated along the periphery of the single insertion hole 50a. The guide plate 50 may include a coupling member support portion 57 provided adjacent to the interference member support portion 58 and to which the coupling member 80 is coupled.

The shearing portion 40 may include a blade 100 arranged below the guide plate 50 and provided to cut the side surface 9b of the inner door frame 9. The blade 100 may extend along the side surface 9b of the inner door frame 9. The blade 100 may be inserted into the inner door frame 9 to cut the side surface 9b of the inner door frame 9.

The shearing portion 40 may include a connecting plate 110 positioned below (−Z direction) the blade 100 and coupled to the blade 100. The connecting plate 110 may be coupled to a connecting member 90 positioned between the guide plate 50 and the connecting plate 110. The connecting member 90 may move the connecting plate 110 in a horizontal direction according to the horizontal movement of the guide plate 50. With such a configuration, the blade 100 coupled to the connecting plate 110 may also be moved in a horizontal direction.

The shearing portion 40 may include a side cam 120 provided between the guide plate 50 and the blade 100. The side cam 120 may be provided on the lower side (−Z direction) of the guide plate 50 and may extend along the side surface 9b of the inner door frame 9 to form a side hole (9d, see FIG. 12) in the side surface 9b of the inner door frame 9.

The connecting member 90 may include an upper hole 91 adjacent to the guide plate 50 and a lower hole 92 adjacent to the connecting plate 110. The guide plate 50 may include a coupling hole 51 communicating with the upper hole 91. The connecting plate 110 may include a connecting hole 112 communicating with the lower hole 92.

A first screw (not shown) may be inserted into the coupling hole 51 and the upper hole 91 such that the guide plate 50 and the connecting member 90 may be coupled to each other. As a second screw (not shown) is inserted into the lower hole 92 and the connecting hole 112, the connecting member 90 and the connecting plate 110 may be coupled to each other. The connecting plate 110 may be coupled to the blade 100 by a third screw (not shown) inserted through the through hole 113 and the blade hole 101.

With such a structure, as the guide plate 50 moves horizontally, the connecting plate 110 may be moved horizontally according to the connecting member 90.

In addition, the blade 100 may also be guided to move horizontally according to the horizontal movement of the connecting member 90.

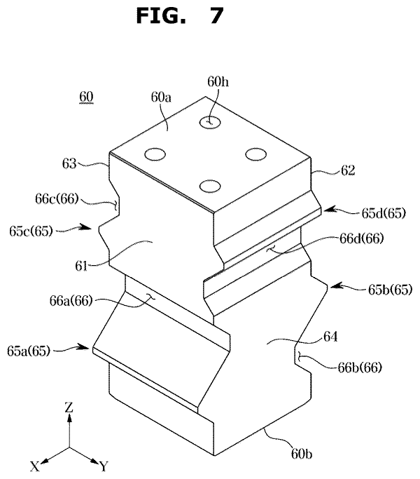

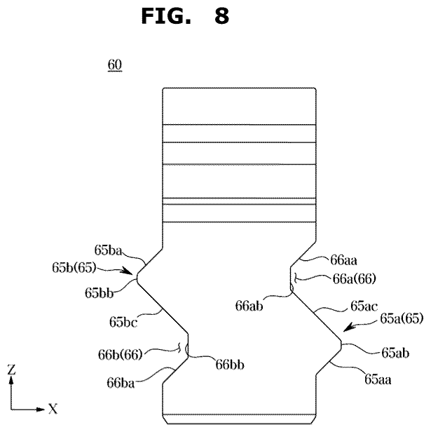

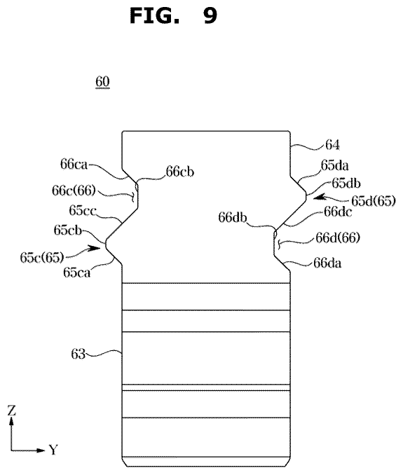

FIG. 7 is a perspective view of a presser shown in FIG. 5. FIG. 8 is a plan view of a presser shown in FIG. 7. FIG. 9 is a plan view of a presser shown in FIG. 7, when viewed from a different angle.

Referring to FIGS. 7 to 9, the presser 60 may include an upper surface 60a and a lower surface 60b. A presser hole 60h may be formed on the upper surface 60a. Although not shown in the drawing, the presser hole 60h may be a hole for connecting to a separate component that is configured to move the presser 60 in the up-and-down direction (Z direction) by being coupled to a component, such as a hydraulic cylinder (not shown) of the upper mold 30.

The presser 60 may be formed in an approximately rectangular solid shape. The presser 60 may include a first side surface 61 facing a first direction (e.g., the X direction), a second side surface 62 facing a second direction (e.g., the −X direction) opposite to the first direction, a third side surface 63 facing a third direction (e.g., the −Y direction), and a fourth side surface 64 facing a fourth direction (e.g., the Y direction) opposite to the third side surface 63.

The presser 60 may include push protrusions 65 protruding from each of the side surfaces 61, 62, 63, and 64 and formed to interfere with interference members 70. The push protrusion 65 may protrude from the side surfaces 61, 62, 63, and 64 of the presser 60 and configured to push the guide plate (50, see FIG. 6) in the horizontal direction as the presser 60 moves in the vertical direction perpendicular to the first direction (e.g., the X direction) to the fourth direction (e.g., the Y direction).

The push protrusion 65 may include a first push protrusion 65a protruding from the first side surface 61 in the first direction (e.g., the X direction) and a second push protrusion 65b protruding from the second side surface 62 in the second direction (e.g., the −X direction). The first push protrusion 65a and the second push protrusion 65b may protrude in opposite directions and may be formed at different heights.

The push protrusion 65 may include a third push protrusion 65c protruding from the third side surface 63 in a third direction (for example, the −Y direction) and a fourth push protrusion 65d protruding from the fourth side surface 64 in a fourth direction (for example, the Y direction) opposite to the third direction. The third push protrusion 65c and the fourth push protrusion 65d may protrude in opposite directions at different heights. In addition, the first push protrusion 65a to the fourth push protrusion 65d may be formed at different heights and protrude in four directions in the horizontal direction, respectively.

The presser 60 may include recessed portions 66 each formed on a respective one of the side surfaces 61, 62, 63, and 64 and formed adjacent to a respective one of the push protrusions 65a, 65b, 65c, and 65d. Each of the recessed portions 66 may be formed to receive an interference member 70 provided at a corresponding position.

More specifically, the first recessed portion 66a may be formed on the first side surface 61 to be positioned upward (the Z direction) of the first push protrusion 65a. The first recessed portion 66a may be formed to correspond to the height of the second push protrusion 65b. The second recessed portion 66b may be formed on the second side surface 62 to be positioned downward (the −Z direction) of the second push protrusion 65b. The second recessed portion 66b may be formed to correspond to the height of the first push protrusion 65a.

Likewise, the third recessed portion 66c may be formed on the third surface 63 to be positioned upward (the Z direction) than the third push protrusion 65c to correspond to the height of the fourth push protrusion 65d. The fourth recessed portion 66d may be formed on the fourth surface 64 to be positioned downward (the −Z direction) than the fourth push protrusion 65d to correspond to the height of the third push protrusion 65c.

The first push protrusion 65a may include a first inclined surface 65aa that protrudes from the first side surface 61 to be inclined in the first direction (for example, the X direction), and a second inclined surface 65ac that extends from the first recessed portion 66a toward the first inclined surface 65aa to be inclined in the first direction (for example, the X direction). The first inclined surface 65aa and the second inclined surface 65ac may be connected to a connecting surface 65ab. That is, one end of the connecting surface 65ab may be connected to the first inclined surface 65aa, and the other end may be connected to the second inclined surface 65ac. The connecting surface 65ab may extend in the vertical direction (the Z direction).

The first inclined surface 65aa may obliquely protrude from the first side surface 61 toward the guide plate (50, see FIG. 6). The second inclined surface 65ac may obliquely protrude from the base surface 66ab of the first recessed portion 66a toward the guide plate 50.

The first recessed portion 66a may include a guide surface 66aa extending from the first side surface 61 in parallel with the first inclined surface 65aa, and a base surface 66ab extending from the guide surface 66aa toward the first push protrusion 65a. The first recessed portion 66a may be formed by the guide surface 66aa, the base surface 66ab, and the second inclined surface 65ac of the first push protrusion 65a.

The first inclined surface 65ba of the second push protrusion 65b may extend from the second side surface 62 in a second direction (for example, the −X direction), which is opposite to the first direction, as being directed downward (the −Z direction), and may be connected to the connecting surface 65bb. The second inclined surface 65bc of the second push protrusion 65b may be located below (the −Z direction) the first inclined surface 65ba and connected to the lower end of the connecting surface 65bb to extend in the first direction (for example, the X direction) as being directed downward (the −Z direction).

The first inclined surface 65ba and the second inclined surface 65bc of the second push protrusion 65b may protrude toward the guide plate 50.

The second recessed portion 66b may include a guide surface 66ba that is inclined in a first direction (for example, the X direction) as being directed upward (the Z direction) from the second side surface 62, and a base surface 66bb that extends from the guide surface 66ba toward the second push protrusion 65b. The guide surface 66ba of the second recessed portion 66b may extend in parallel with the first inclined surface 65ba of the second push protrusion 65b.

As described above, the configurations of the first inclined surface 65ca, the second inclined surface 65cc, and the connecting surface 65cb of the third push protrusion 65c, and the guide surface 66ca and the base surface 66cb of the third recessed portion 66c, and the configurations of the first inclined surface 65da, the second inclined surface 65dc, and the connecting surface 65db of the fourth push protrusion 65d and the guide surface 66da and the base surface 66db of the fourth recessed portion 66d may be formed to correspond to the configurations of the first push protrusion 65a and the first recessed portion 66a and the configurations of the second push protrusion 65b and the second recessed portion 66b, except that the inclined directions are different.

As the presser 60 moves downward relative to the guide plate 50 through the insertion hole 50a of the guide plate 50, the first push protrusion 65a, the second push protrusion 65b, the third push protrusion 65c, and the fourth push protrusion 65d may sequentially pass through the insertion hole 50a (see FIG. 5).

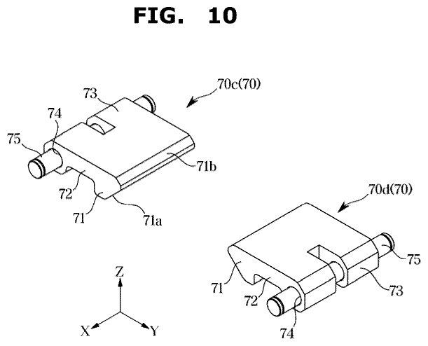

FIG. 10 is a perspective view of an interference member shown in FIG. 5. Referring to FIG. 10, the interference member 70 may be provided in plural to correspond to each of the push protrusions 65. For example, four interference members 70 may be provided for a single insertion hole 50a.

In FIG. 10, the third interference member 70c and the fourth interference member 70d facing each other are illustrated, but each interference member may have a shape corresponding to each other. Each of the interference members 70 may include an interference portion 71, a hinge coupling portion 73 into which a hinge shaft 75 is inserted, and a connecting portion 72 connecting the interference portion 71 and the hinge coupling portion 73. The hinge coupling portion 73 may have a hinge hole 74 into which the hinge 75 is inserted.

The interference portion 71 may include a first slide surface 71a and a second slide surface 71b. Each of the slide surfaces 71a and 71b may be inclined to slide with respect to the inclined surface 65aa, 65ac, 65ba, 65bc, 65ca, 65cc, 65da, or 65dc of the push protrusion 65 or the guide surface 66aa, 66ba, 66ca, or 66da of the recessed portion 66.

FIG. 11 is a perspective view of a coupling member shown in FIG. 5. Referring to FIG. 11, the coupling member 80 may be provided in plural to correspond to each of the interference members 70. However, as shown in FIG. 6, the coupling member 80d provided between a pair of insertion holes 50a may be provided as a single coupling member corresponding to a pair of push protrusions 65. However, the disclosure is not limited thereto.

In FIG. 11, the third coupling member 80c coupled to the third interference member 70c that interferes with the third push protrusion (65c, see FIG. 7), and the fourth coupling member 80d coupled to the fourth interference member 70d that interferes with the fourth push protrusion 65d are illustrated. The first coupling member 80a and the second coupling member 80b respectively coupled to the first interference member 70a and the second interference member 70b, which interfere with the first push protrusion 65a and the second push protrusion 65b, respectively, may have shapes corresponding to the third coupling member 80c.

The coupling member 80 may be coupled to the guide plate (50, see FIG. 6) and configured to move the guide plate 50 via the interference member 70.

The third coupling member 80c may include a first coupling body 81 and a first hinge fixing member 82 protruding from the first coupling body 81 toward the interference member 70. The first coupling body 81 may include a first interference fixing hole 80ch. The first interference fixing hole 80ch may be a hole for being coupled to an interference member support portion (57, see FIG. 6). The first hinge fixing member 82 may form a first hinge insertion member 83 and may have a first hinge insertion hole 84.

The fourth coupling member 80d may be configured to be coupled to a pair of interference members 70 in opposite directions in the horizontal direction. The fourth coupling member 80d may include a second coupling body 85 arranged between a pair of insertion holes 50a of the guide plate (50, see FIG. 6). The fourth coupling member 80d may include a pair of second hinge fixing portions 86 protruding from the second coupling body 85 in opposite directions (e.g., the Y direction and the −Y direction).

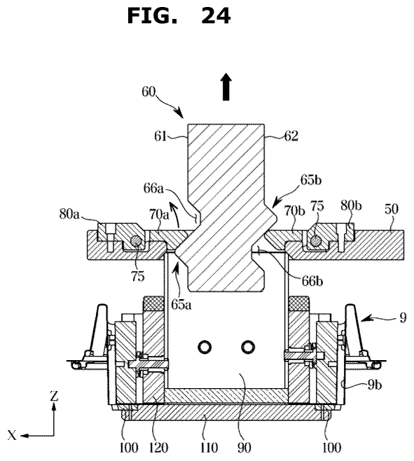

Similar to the third coupling member 80c, the second coupling body 85 may have a second interference fixing hole 80dh and may be coupled to the guide plate 50 through the second interference fixing hole 80dh. The second hinge fixing portion 86 may form a second hinge insertion portion 87 and may have a first hinge insertion hole 88, through which the second hinge fixing portion 86 may be hinge-coupled to a pair of interference members 70. According to this structure, the interference member 70 may rotate in place with respect to the coupling member 80 through the hinge shaft (75, see FIG. 24).

FIG. 12 is a schematic view of a shearing process of an inner door frame according to an embodiment of the disclosure. Referring to FIG. 12, the inner door frame 9 before and after shearing will be described by comparison.

A product before shearing of the inner door frame 9 may be a thermoformed product and may be referred to as an inner door intermediate product 9-1. A product obtained by shearing the inner door intermediate product 9-1 may be referred to as a finished inner door product 9-2.

The shearing may be divided into a total of three stages. It may be composed of an outer trimming process for shearing an uneven outer edge line located at the edge of an inner door intermediate product 9-1 before shear forming, an open trimming process for cutting a side surface 9b of the inner door intermediate product 9-1 before shear forming such that an opening 9a of the inner door intermediate product 9-1 is formed, and a side cam piercing process for forming a side hole 9d for a door guard (150, see FIG. 1).

Through the outer trimming process, a first scrap S1 may be formed from the inner door intermediate product 9-1 before shear forming. Through the open trimming process, a second scrap S2 may be formed from the inner door intermediate product 9-1. Through the side cam piercing process, a third scrap S3 may be formed from the inner door intermediate product 9-1.

The inner door intermediate product 9-1 may be referred to as an door intermediate product 9-1, a side surface 9b of the inner door intermediate product 9-1 may be referred to as a side surface 9b of the inner door frame 9, and an opening 9a of the finished inner door product 9-2 may be referred to as an opening 9a of the inner door frame 9.

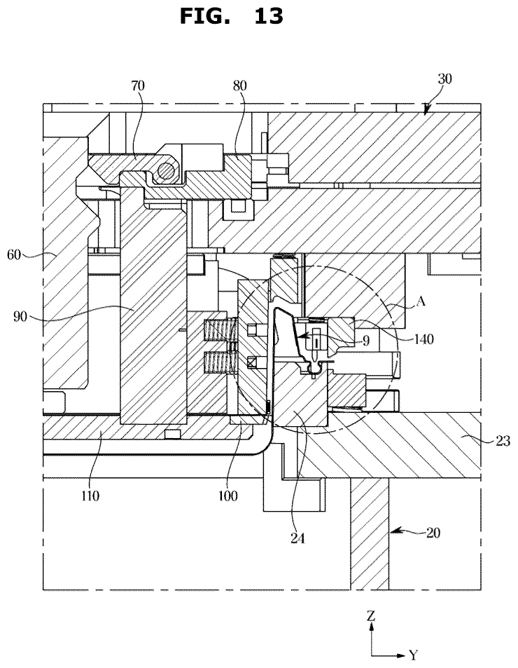

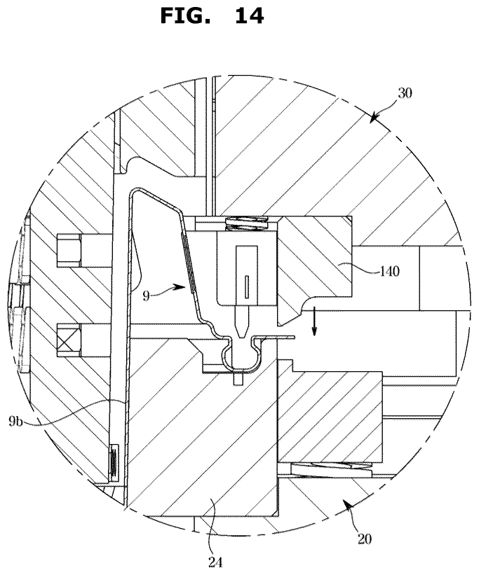

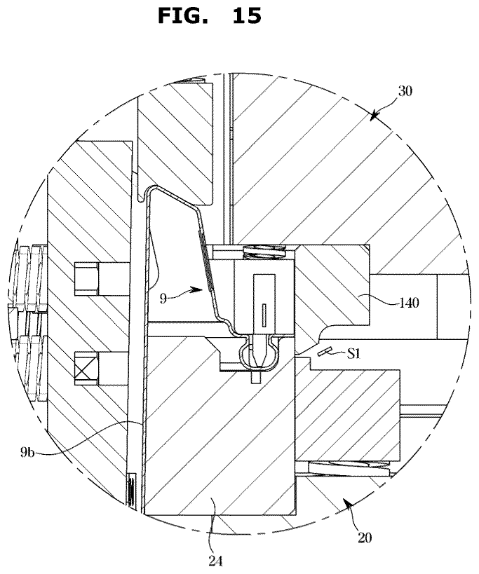

FIG. 13 is an enlarged side-sectional view for describing an outer trimming process of an upper mold according to an embodiment of the disclosure. FIG. 14 is an enlarged view of part A of FIG. 13, showing a state before the upper mold is moved toward the lower mold. FIG. 15 is an enlarged view of part A of FIG. 13, showing a state after the upper mold is moved toward the lower mold.

The outer trimming process will be described in detail with reference to FIGS. 13 to 15. The upper mold 30 may be moved to become closer to the lower mold 20. As the components of the upper mold 30 are moved to become closer to the components of the lower mold 20, a first scrap S1 cut from the inner door frame 9 may be formed. The first scrap S1 may be formed on the edge of the inner door frame 9.

The upper mold 30 may include a cutter 140 provided to cut the first scrap S1 from the inner door frame 9. The cutter 140 may be formed to be pointed toward the lower mold 20.

As the upper mold 30 is moved toward the lower mold 20, the cutter 140 may cut a portion located on the edge of the inner door frame 9. Accordingly, the first scrap S1 may be cut from the inner door frame 9 and moved toward the outside of the lower mold 20.

According to this structure, the outer edge line of the inner door frame 9 may become neater, thereby improving the quality of the manufacturing process of the inner door frame 9.

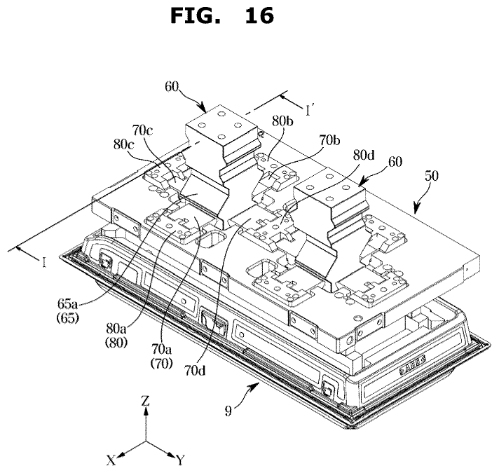

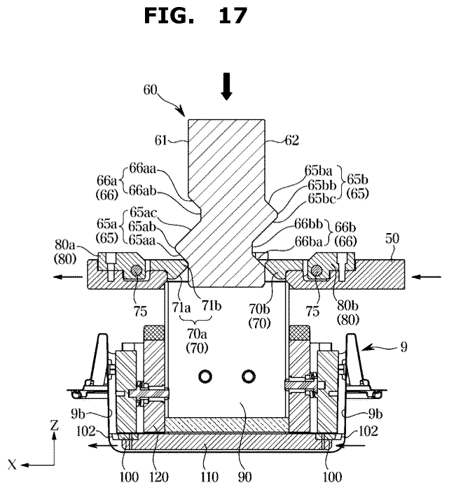

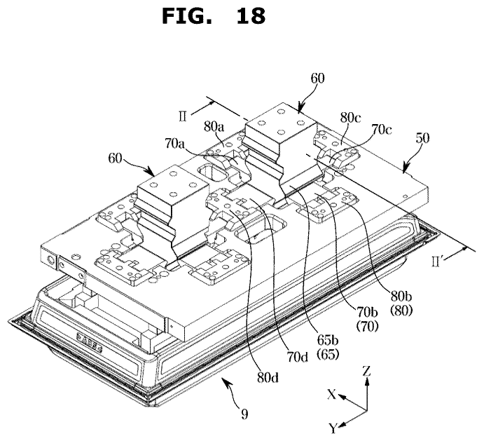

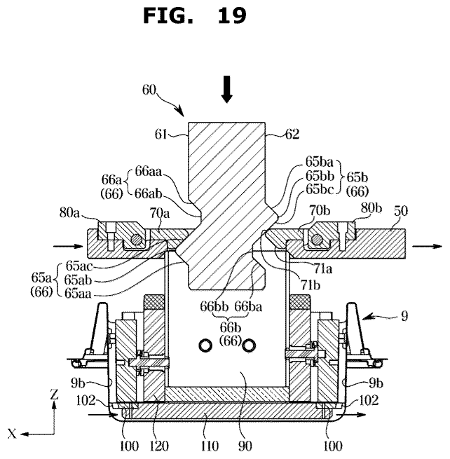

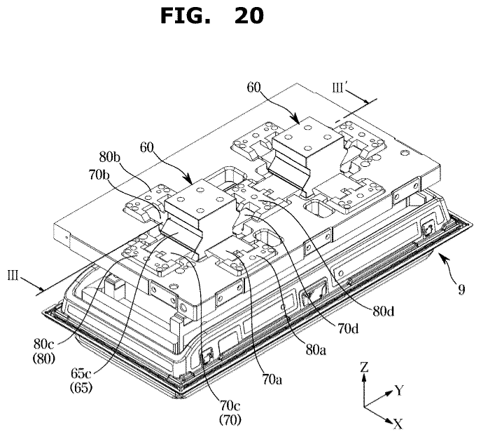

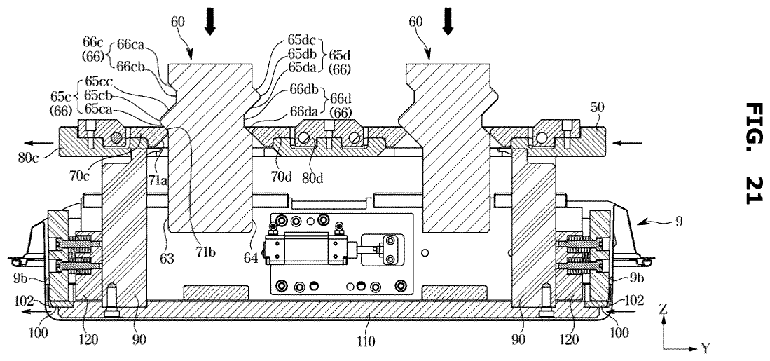

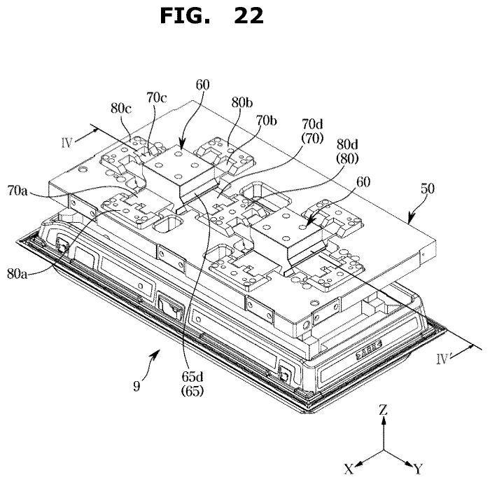

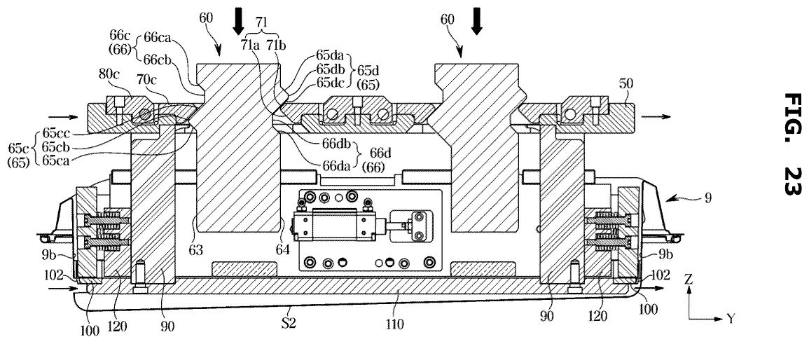

FIG. 16 is a perspective view showing a state in which a first push protrusion of a presser is moved downward toward a guide plate and interferes with a first interference member according to an embodiment of the disclosure. FIG. 17 is a sectional view of an upper mold and an inner door frame taken along line I-I′ of FIG. 16. FIG. 18 is a perspective view showing a state in which a second push protrusion of a presser is moved downward toward a guide plate and interferes with a second interference member according to an embodiment of the disclosure. FIG. 19 is a sectional view of an upper mold and an inner door frame taken along line II-II′ of FIG. 18. FIG. 20 is a perspective view showing a state in which a third push protrusion of a presser is moved downward toward a guide plate and interferes with a third interference member according to an embodiment of the disclosure. FIG. 21 is a sectional view illustrating an upper mold and an inner door frame taken along line III-III′ of FIG. 20. FIG. 22 is a perspective view showing a state in which a fourth push protrusion of a presser is moved downward toward a guide plate and interferes with a fourth interference member according to an embodiment of the disclosure. FIG. 23 is a sectional view of an upper mold and an inner door frame taken along line IV-IV′ of FIG. 22.

Referring to FIGS. 16 to 23, the open trimming process of the inner door frame 9 will be described in detail. The interference member 70 may be provided between the presser 60 and the guide plate 50 to interfere with the push protrusion 65.

When the presser 60 moves downward (the −Z direction) with respect to the guide plate 50, the first push protrusion 65a of the presser 60 may reach a position in which the first push protrusion 65a engages with the first interference member 70a. In this case, the second push protrusion 65b to the fourth push protrusion 65d arranged upward of the first push protrusion 65a may not interfere with the second interference member 70b to the fourth interference member 70d.

As the presser 60 moves closer to the connecting plate 110, the first interference member 70a in contact with the first side surface 61 may interfere with the first inclined surface 65aa of the first push protrusion 65a. In this case, the second slide surface 71b of the first interference member 70a may interfere with the first inclined surface 65aa of the first push protrusion 65a. Since the first inclined surface 65aa of the first push protrusion 65a is shaped to be inclined in the first direction (for example, the X direction), the first interference member 70a may be moved in the first direction (for example, the X direction) in the horizontal direction by the first push protrusion 65a.

Due to the structure of the second push protrusion 65b, which protrudes in the second direction (e.g., the −X direction) opposite to the first direction (e.g., the X direction), and the second recessed portion 66b, the first slide surface 71a of the second interference member 70b may slide along the guide surface 66ba of the second recessed portion 66b.

For this process, the guide surface 66ba of the second recessed portion 66b may be parallel to the first slide surface 71a and parallel to the first inclined surface 65ba of the second push protrusion 65b. The second interference member 70b may move in the first direction (e.g., the X direction) along the guide surface 66ba of the second recessed portion 66b and come into contact with the base surface 66bb of the second recessed portion 66b.

That is, as the presser 60 moves downward (the −Z direction) through the insertion hole (50a, see FIG. 4) of the guide plate 50, the guide plate 50 coupled to the first interference member 70a and the second interference member 70b may move in a first direction (for example, the X direction) in the horizontal direction due to the structure of the first push protrusion 65a and the second recessed portion 66b provided at a height corresponding to the first push protrusion 65a.

As described above, when the guide plate 50 moves in the first direction (for example, the X direction), the connecting member 90, the connecting plate 110, and the blade 100 coupled to the guide plate 50 may move in the first direction (for example, the X direction).

When the blade 100 is moved in the first direction (for example, the X direction), a portion of the side surface 9b of the inner door frame 9 located in the first direction (for example, the X direction) may be cut by a blade surface 102 of the blade 100 that is provided with a pointed shape.

After the first push protrusion 65a interferes with the first interference member 70a, when the presser 60 further moves downward (the −Z direction), the second push protrusion 65b located on the opposite side of the first push protrusion 65a may interfere with the second interference member 70b.

More specifically, as the presser 60 is moved downward (the −Z direction), the second slide surface 71b of the second interference member 70b may interfere with the second inclined surface 65bc of the second push protrusion 65b. As the presser 60 moves downward (the −Z direction), the first slide surface 71a of the first interference member 70a may slide along the slope of the second inclined surface 65ac of the first push protrusion 65a.

That is, the first interference member 70a may be moved in the second direction (for example, the −X direction) to be inserted into the first recessed portion 66a, and the second interference member 70b may be moved in the second direction (for example, the −X direction) by the second push protrusion 65b.

According to this structure, after the guide plate 50 is moved in the first direction (e.g., the X direction) due to the interference of the first push protrusion 65a and the first interference member 70a, the second push protrusion 65b and the second interference member 70b may subsequently interfere with each other, causing the guide plate 50 to move in the second direction (e.g., the −X direction) opposite to the first direction.

The connecting member 90, the connecting plate 110, and the blade 100 may also move in the second direction (for example, the −X direction) in which the guide plate 50 moves. According to this structure, a portion of the inner door frame 9 in the second direction (for example, the −X direction) may be cut by the blade surface 102 of the blade 100.

When the presser 60 is further moved downward (for example, the −Z direction), the third push protrusion 65c protruding from the third side surface 63 in the third direction (for example, the −Y direction) that is perpendicular to the first direction (for example, the X direction) and the second direction (for example, the −X direction) may interfere with the third interference member 70c.

More specifically, the second slide surface 71b of the third interference member 70c may interfere with the first inclined surface 65ca of the third push protrusion 65c. The first slide surface 71a of the fourth interference member 70d may slide along the guide surface 66da of the fourth recessed portion 66c in the fourth direction (e.g., the Y direction) opposite to the third direction (e.g., the −Y direction) with respect to the presser 60.

According to this structure, as the presser 60 is continuously moved downward (the −Z direction), the guide plate 50 may be moved in the first direction (e.g., the X direction), the second direction (e.g., the −X direction), and the third direction (e.g., the −Y direction). As described above, the blade 100 may also be moved in the third direction (for example, the −Y direction) such that a portion of the side surface 9b of the inner door frame 9 in the third direction (for example, the −Y direction) may be cut by the blade surface 102.

After the third push protrusion 65c and the third interference member 70c interfere with each other, when the presser 60 moves toward the connecting plate 110, the fourth push protrusion 65d formed on the fourth side surface 64 of the presser 60 may interfere with the fourth interference member 70d.

The second inclined surface 65dc and the connecting surface 65db of the fourth push protrusion 65d may push the first slide surface 71a of the fourth push protrusion 70d in the fourth direction (for example, the Y direction) opposite to the third direction (for example, the −Y direction). In the third direction (for example, the −Y direction) with respect to the presser 60, the third interference member 70c may be moved in the fourth direction (for example, the Y direction) as the third interference member 70c is inserted into the third recessed portion 66c.

As the guide plate 50 moves in the fourth direction (for example, the Y direction), the blade 100 may also be moved in the fourth direction (for example, the Y direction), and all four side surfaces 9b of the inner door frame 9 may be cut. As a result, through the open trimming process, the inner door frame 9 may be provided with an opening (9a, see FIG. 2) such that the front side is open.

According to the above-described structure, as the presser 60 is continuously moved in the vertical direction (the −Z direction), the guide plate 50, the connecting member 90, the connecting plate 110, and the blade 100 may all sequentially moved in the first direction (for example, the X direction) to the fourth direction (for example, the Y direction) in the horizontal direction, thereby allowing the opening 9a of the inner door frame 9 to be easily formed.

In this way, the mold apparatus (10, see FIG. 4) may trim the inner door frame 9 such that the inner door frame 9 is opened at the front by simply moving the presser 60 of the shearing portion 40 to the lower mold 20. Due to this structure, the manufacturing speed of the inner door frame 9 may be improved.

FIG. 24 is a side sectional view showing a process in which a push protrusion of a presser is moved toward an upper side of a guide plate to rotate an interference member according to an embodiment of the disclosure.

Referring to FIG. 16 and FIG. 24, after the inner door frame 9 is formed such that the front side is open, as the presser 60 moves upward (the Z direction) away from the connecting plate 110, the fourth push protrusion 65d, the third push protrusion 65c, the second push protrusion 65b, and the first push protrusion 65a may sequentially come into contact with the fourth interference member 70d, the third interference member 70c, the second interference member 70b, and the first interference member 70a. In FIG. 24, a case in which the first push protrusion 65a and the first interference member 70a interfere with each other is illustrated, but this may also apply to the other structures.

As the presser 60 moves upward (the Z direction), the first interference member 70a inserted into the first recessed portion 66 may be pressed upward by the first push protrusion 65a. Since the first interference member 70a is hinge-coupled to the first coupling member 80a through the hinge shaft 75, the first interference member 70a may rotate in place counterclockwise around the hinge shaft 75.

According to this structure, even when the presser 60 moves away from the connecting plate 110 after the side surface 9b of the inner door frame 9 is cut, the guide plate 50 may be prevented from moving in the horizontal direction. With such a configuration, the blade 100 may also be prevented from moving in the horizontal direction, thereby preventing the side surface 9b of the inner door frame 9 being double-cut. With such a configuration, the quality of the inner door frame 9 may be improved, which may enhance the consumer satisfaction.

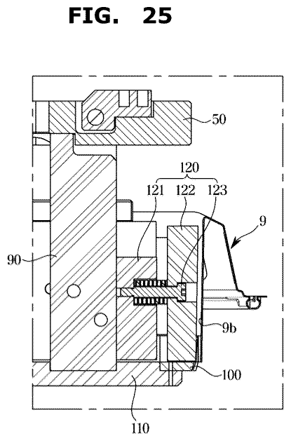

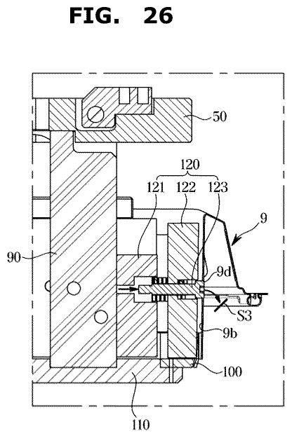

FIG. 25 is an enlarged side surface-sectional view showing a side cam piercing process of an upper mold according to an embodiment of the disclosure, which shows a state before a side cam moves toward an inner door frame. FIG. 26 is an enlarged side surface-sectional view showing a side cam piercing process of an upper mold according to an embodiment of the disclosure, which shows a state after a side cam moves toward an inner door frame.

Referring to FIGS. 25 and 26, the side cam piercing process will be described in detail. In FIGS. 25 and 26, enlarged views of the side surface 9b of the inner door frame 9 are illustrated.

The side cam 120 may include a side punch 123 configured to move toward the side surface 9b of the inner door frame 9 to form a side hole 9d in the side surface 9b of the inner door frame 9 after the outer trimming process and the open trimming process are completed.

The side cam 120 may include a first support portion 121 and a second support portion 122 that support the side punch 123. The side cam 120 may include a hydraulic cylinder (not shown) that is provided to move the side punch 123. However, it is not limited to a hydraulic cylinder, and any configuration for moving the side punch 123 toward the side surface 9b of the inner door frame 9 is sufficient.

When the side punch 123 is pressed by another configuration and moves toward the side surface 9b of the inner door frame 9, a side hole 9d may be formed in the side surface 9b of the inner door frame 9 that is thin. Through the side hole 9d, the door bead 9c may be coupled to the inner door frame 9. A third scrap S3 corresponding to the shape of the side punch 123 may be separated from the side surface 9b of the inner door frame 9.

The inner door frame 9 may be formed through a shear forming through an outer trimming process, an open trimming process, and a side cam piercing process, thereby forming the inner door frame (9-2, see FIG. 12) after the shear forming.

The above description has been made with respect to the mold apparatus 10 for manufacturing the inner door frame 9 of the refrigerator, but is not limited to the inner door 8 of the refrigerator, and may also be used for manufacturing doors of other home appliances.

While the specific embodiments of the preset invention have been illustrated and described above, the present invention is not limited to the above-described embodiments and may be variously modified and made by those skilled in the art without departing from the gist of the technological sprit of the present invention defined by the appended claims.

1. A mold apparatus for manufacturing a door having an opening by shearing a door intermediate product, the mold apparatus comprising:
a lower mold to correspond to the door intermediate product; and
an upper mold, to correspond to the door intermediate product, to be positioned above the lower mold,
wherein the upper mold comprises:
a blade extending along a side surface of the door intermediate product to cut a side surface of the door intermediate product;
a guide plate, including an insertion hole, configured to guide a movement of the blade along a horizontal direction; and
a presser, including a push protrusion, configured to move along one direction perpendicular to the horizontal direction through the insertion hole, wherein the push protrusion protrudes from a side surface of the presser to push the guide plate along the horizontal direction as the presser moves along the one direction.

2. The mold apparatus of claim 1, wherein the side surface of the presser is a first side surface facing a first direction along a horizontal direction and the presser includes a second side surface facing a second direction along a horizontal direction different from the first direction, and
the push protrusion is a first push protrusion formed on the first side surface and the presser includes a second push protrusion on the second side surface at a height different from a height of the first push protrusion.

3. The mold apparatus of claim 1, wherein the upper mold further includes an interference member between the presser and the guide plate to interfere with the push protrusion.

4. The mold apparatus of claim 3, wherein the upper mold further includes a coupling member, coupleable to the guide plate, configured to move the guide plate via the interference member, and
the interference member is configured to rotate around the coupling member.

5. The mold apparatus of claim 4, wherein the interference member is configured to rotate around the coupling member as the presser moves in another direction opposite to the one direction.

6. The mold apparatus of claim 3, wherein the presser further includes a recessed portion adjacent to the push protrusion and into which the interference member is insertable.

7. The mold apparatus of claim 6, wherein the push protrusion includes a first inclined surface protruding from the side surface to be inclined toward the guide plate, a connecting surface extending from one end thereof connected to the first inclined surface, and a second inclined surface extending from an other end of the connecting surface and inclined toward the side surface.

8. The mold apparatus of claim 7, wherein the recessed portion includes a bottom surface including one end connected to the first inclined surface, and a guide surface extending parallel to the second inclined surface from an other end of the bottom surface.

9. The mold apparatus of claim 7, wherein the interference member includes a first slide surface inclined parallel with the first inclined surface to be slidable relative to the first inclined surface, and a second slide surface inclined parallel with the second inclined surface to be slidable relative to the second inclined surface.

10. The mold apparatus of claim 2, wherein the side surface of the presser is a first side surface facing a first direction along a horizontal direction, and the presser includes a second side surface facing a second direction that is opposite to the first direction along the horizontal direction,
the push protrusion is a first push protrusion formed on the first side surface, and the presser includes a second push protrusion formed on the second side surface and positioned upward of the first push protrusion, and
the upper mold includes a first interference member between the presser and the guide plate to interfere with the first push protrusion, and a second interference member provided between the presser and the guide plate to interfere with the second push protrusion.

11. The mold apparatus of claim 10, wherein the presser includes a first recessed portion on the first side surface at a height of the second push protrusion, and a second recessed portion on the second side surface at a height of the first push protrusion.

12. The mold apparatus of claim 11, wherein
the first push protrusion includes a first inclined surface inclined upward from the first side surface and a second inclined surface inclined downward from a bottom surface of the first recessed portion,
the second push protrusion includes a third inclined surface inclined downward from the second side surface and a fourth inclined surface inclined upward from a bottom surface of the second recessed portion,
the first interference member includes a first slide surface extending parallel to the first inclined surface to be slidable on the first inclined surface, and a second slide surface extending parallel to the second inclined surface to be slidable on the second inclined surface and positioned downward of the first slide surface, and
the second interference member includes a third slide surface extending parallel to the fourth inclined surface to be slidable on the fourth inclined surface, and a fourth slide surface extending parallel to the third inclined surface to be slidable on the third inclined surface.

13. The mold apparatus of claim 1, wherein the blade is insertable into the door intermediate product to cut the side surface of the door intermediate product.

14. The mold apparatus of claim 4, wherein the interference member includes a hinge coupling portion into which a hinge shaft configured to rotate the interference member is insertable, the hinge coupling portion being coupled to the coupling member, and
the coupling member includes a hinge fixing portion into which the hinge shaft is inserted.

15. The mold apparatus of claim 1, wherein the upper mold further includes a connecting plate coupled to the blade and configured to move the blade along the horizontal direction in response to the guide plate being moved along the horizontal direction.
